(19) United States
(12) Patent Application Publication
(10) Pub. No.: US 2023/0014631 A1
(43) Pub. Date: Jan. 19, 2023

(54) A DISPENSER

(71) Applicant: EDLYN FOODS PTY LTD., Melbourne, Victoria (AU)

(72) Inventors: JACQUELINE SAVAGE, Melbourne, Victoria (AU); Matthew Kempe, Melbourne, Victoria (AU); Andrew Weeks, Melbourne, Victoria (AU); Andrew Donelly, Melbourne, Victoria (AU); Aida Golneshin, 13 Ricky Way (AU); Thomas Shelley, Melbourne, Victoria (AU); Brittany Puyol, Melbourne, Victoria (AU)

(21) Appl. No.: 17/786,291

(22) PCT Filed: Dec. 16, 2020
(86) PCT No.: PCT/AU2020/051376

§ 371 Date: Jun. 16, 2022

(30) Foreign Application Priority Data
Dec. 17, 2019 (AU) 2019904760

(51) Int. Cl. B65D 83/00; B65D 47/20

(52) U.S. Cl. CPC B65D 83/0055; B65D 47/2018; B65D 2231/001

(57) ABSTRACT

The invention relates to a dispenser, such as of the type that is adapted to be squeezed to dispense its contents. The dispenser comprises: at least one container engaging element adapted to engage a flexible container containing contents to be dispensed, the at least one container engaging element including a dispensing opening configured to receive and dispense the contents of the flexible container through the dispensing opening; and a base operatively associated with the at least one container engaging element and including an opening configured to receive the dispensing opening of the at least one container engaging element; wherein the at least one container engaging element is configured to maintain at least a portion of the flexible container in a predetermined position, wherein the contents of the flexible container are dispensed upon pressure being applied to the flexible container.

### FIELD OF THE INVENTION

The present invention relates to dispensers that are adapted to be squeezed to thereby dispense their contents. The present invention has particular application to squeezable bottles containing condiments, such as ketchup, sauce, mustard, mayonnaise, salad dressing, and the like, but is not limited to such applications.

### BACKGROUND OF THE INVENTION

Squeezable bottles for dispensing condiments, such as ketchup, mustard, and the like are generally well known. One common design, which is readily usable and understandable, involves removing a cap from a generally pointed dispensing opening or tip, inverting the bottle, and then squeezing the bottle to dispense its contents. One of the primary problems associated with the use of such a squeezable bottle is wastage. Specifically, it is generally difficult to extract the last remaining contents of the bottle. To address this issue, one approach has been to design squeezable bottles that are usable and storable in a generally inverted orientation, with the dispensing opening located in a lower end of the bottle upon which the bottle rests when stored. In this way, the contents of the bottle may be dispensed without firstly inverting the bottle. In this design, the dispensing opening includes a valve that, for the most part, is leak resistant.

For commercial applications, large condiment containers having a plunger-type valve extending from a top opening of the container are more commonly used than squeezable hand-held bottles. Dispensing containers of this form have certain drawbacks however. For example, these condiment containers are typically re-filled by decanting from other larger containers. This process increases the risk of spillages, and also exposes the condiment to the environment, which may result in reduced product life and therefore potential wastage.

An alternative approach is disclosed in U.S. Pat. No. 9,522,405. In that approach, a generally flexible container containing contents to be dispensed is inserted into a dispenser for use.

The present invention proposes an alternative dispenser design that may address one or more problems of prior designs.

Reference to any prior art in the specification is not an acknowledgment or suggestion that this prior art forms part of the common general knowledge in any jurisdiction or that this prior art could reasonably be expected to be combined with other pieces of prior art by a skilled person in the art.

### SUMMARY OF THE INVENTION

In a first aspect, the present invention provides a dispenser comprising at least one container engaging element adapted to engage a flexible container containing contents to be dispensed, the at least one container engaging element including a dispensing opening configured to receive and dispense the contents of the flexible container through the dispensing opening; and a base operatively associated with the at least one container engaging element and including an opening configured to receive the dispensing opening of the at least one container engaging element; wherein the at least one container engaging element is configured to maintain at least a portion of the flexible container in a predetermined position, wherein the contents of the flexible container are dispensed upon pressure being applied to the flexible container.

The at least one container engaging element may be movable to a position in order to maintain the at least a portion of the flexible container in the predetermined position.

In one embodiment, the pressure may be directly applied to the flexible container by squeezing the flexible container. In an alternative embodiment, the at least one container engaging element may be removably received within a dispenser body. The dispenser body preferably defines an internal space for receiving the at least one container engaging element. In this embodiment, the pressure may be indirectly applied to the flexible container by squeezing the dispenser body, wherein squeezing the dispenser body causes an increase in air pressure within the internal space, which increase in air pressure applies pressure to the flexible container to thereby dispense its contents.

The dispenser body is preferably of assymetrical form, having a generally circular cross-section at the first end thereof, and a generally elliptical cross-section at the second end thereof. Preferably, the cross-section at the second end of the dispenser body lies in a plane that is angled relative to a plane in which the cross-section at the first end of the dispenser body lies. The first end is preferably a lower end of the dispensing body and the second end is preferably an upper end of the dispensing body. Providing the dispenser body with one or more of the above features enhances the overall ergonomic form of the dispenser body.

The dispenser body preferably includes a one-way air valve. The one-way air valve is configured to close upon squeezing of the dispenser body, thereby preventing air within the internal space from exiting via the one-way valve. Specifically, as the dispenser body is squeezed, the volume of the internal space decreases causing a corresponding increase in air pressure within the internal space. The increase in air pressure forces the one-way air valve to close. The increase in air pressure additionally causes the flexible container to deform, thereby forcing the contents of the flexible container to be dispensed via the dispensing opening in the at least one container engaging element. A partial vacuum may be formed within the flexible container as its contents are dispensed. The increase in air pressure within the internal space coupled with the partial vacuum within the flexible container causes the flexible container to at least partially fold over or collapse into at least a portion of the at least one container engaging element or a cavity defined by the at least one container engaging element. This ensures that substantially all of the contents of the flexible container are dispensed during use.

The one-way air valve is preferably provided at or towards the upper end of the dispenser body. The one-way air valve may be an umbrella type valve. Preferably, the one-way air valve is a duckbill type valve. However, the one-way valve may be any other one-way valve that a person skilled in the art would consider suitable.

Once squeezing pressure on the dispenser body has been released, the one-way air valve opens and allows air to be drawn into the dispenser body to thereby equalize the air pressure within the internal space.

The at least one container engaging element is also preferably removably receivable within the flexible container. The flexible container preferably includes a closed end and an openable end opposite to the closed end. When the flexible container is opened at its openable end, the at least one container engaging element is removably receivable therein. When received within the flexible container, the at least one container engaging element engages at least a wall of the flexible container to maintain the wall in a predetermined position. Preferably, the wall is an internal wall of the flexible container. The predetermined position corresponds to a substantially open position of the flexible container. The at least one container engaging element also preferably includes a seal. When the at least one container engaging element is received within the flexible container, the seal may contact at least a portion of the flexible container. Preferably, the seal of the at least one container engaging element does not contact the flexible container. The seal may be located on a flange of the at least one container engaging element. The seal preferably provides a fluidic (e.g. air tight) seal between the at least one container engaging element and the dispenser body. Preferably, engagement between the base, dispenser body and at least one container engaging element provides a compressive load to the seal to create the fluidic seal and ensures that the seal is operatively retained when the dispenser is assembled. The seal may be a separate removable element, such as an O-ring seal, or may be moulded onto an outer surface of the at least one container engaging element. The seal may comprise rubber or silicone. The seal can be of any suitable cross-sectional profile shape, such as circular, rectangular, U-shaped, L-shaped, etc.

Preferably, the at least one container engaging element extends at least partially along a length of the flexible container. Preferably, the at least one container engaging element extends in a range of between about 30% to 50% of the length of the flexible container. The flexible container is preferably deformable, collapsible, foldable, and invertible. The flexible container is preferably in the form of a pouch, or a bag, or a liner. The flexible container preferably comprises a thin film-like material. The flexible container may be disposed of after use. In one embodiment, the flexible container has a width of about 100 mm and a length of about 300 mm, and a tearable notch located in its external wall about 220 mm along its length. The flexible container may also include a seam of no more than 5 mm along its side edges such that the contents of the container are located in a cavity that is about 90 mm in width and 300 mm in length. The bottom edge may also include a seam of no more than 5 mm length, although preferably the bottom edge is associated with a fold line of the thin film-like material and therefore requires no additional seam. Ultimately, the flexible container should not be so rigid that it cannot be deformable, collapsible, foldable, and invertible.

As is described above, the at least one container engaging element includes the dispensing opening. The dispensing opening is configured to receive the contents of the flexible container to thereby dispense the contents through the opening. The dispensing opening may be closeable. The dispensing opening preferably includes a valve. The valve is preferably a one-way valve that allows the contents of the flexible container to be dispensed therethrough, but prevents air from entering the flexible container from the external environment. Advantageously therefore, the one-way valve acts to preserve the contents of the flexible container and to prevent spoiling of the contents of the flexible container. The one-way valve may be a duckbill type valve, or may be any other one-way valve that a person skilled in the art would consider suitable. The valve may be of variable size and shape and/or interchangeable with another valve that provides different flow characteristics, such as a different flow rate. The valve may be integrally formed with the at least one container engaging element or be provided as a separate component that is secured to the at least one container engaging element, e.g. over moulded onto the container engaging element.

As is described above, the dispenser also includes a base that is operatively associated with the at least one container engaging element. The base is preferably connectable (e.g. rotatably connectable) to the dispenser body to secure the base to the dispenser body. Furthermore, the base is preferably connectable (e.g. rotatably connectable) to the at least one container engaging element to secure the base to the at least one container engaging element. The base includes an opening. The opening is configured to receive the dispensing opening of the at least one container engaging element.

In a preferred method of assembling the dispenser, the at least one container engaging element is firstly secured to the base. The at least one container engaging element is then inserted into the opened end of the flexible container. Lastly, the combined base, container engaging element, and flexible container are inserted into the internal space of the dispenser body. The base is then secured to the dispenser body. Preferably, when the base is secured to the dispenser body, at least a portion of the flexible container is secured between the at least one container engaging element and the dispenser body. Furthermore, the dispenser body preferably engages the seal, such that internal space is sealed or substantially sealed. Preferably, the flexible container does not contact the base during or after assembly of the dispenser.

The dispenser body may include a tapered or grooved section, wherein the tapered or grooved section is adapted to engage the flexible container and the at least one container engaging element to prevent or reduce the likelihood of the flexible container moving relative to the at least one container engaging element. This is particularly advantageous as squeezing of the dispenser body can lead to the flexible container moving out of engagement with the at least one container engaging element. The tapered or grooved section can thus impart sufficient retaining forces onto the flexible container and the at least one container engaging element to prevent this movement.

The tapered or grooved section may include one or more projections extending radially therefrom. An inner side of each projection may define at least in part a channel within the dispenser body. The channel is configured to provide a passage for air away from the internal space of the dispenser body when the dispenser body is being assembled with the base. Advantageously, the channel(s) ensure that air can move away from the internal space of the dispenser body and prevent any inadvertent application of pressure on the flexible container during assembly. Such pressure could otherwise lead to premature dispensing of the contents from the flexible container during assembly. Preferably, there are a plurality of projections arranged equidistantly about a circumference of the tapered or grooved section, thereby resulting in a plurality of channels within the dispenser body.

When assembled, the dispenser may rest on a surface via the base, such that the flexible container is in a generally inverted orientation with the dispensing opening of the at least one container engaging element generally facing the surface. In this position, the at least one container engaging element preferably extends from the base generally upwardly within the dispenser body generally adjacent an inner side wall of the dispenser body, and extends at least partially along a length of the dispenser body. The at least one container engaging element may extend along at least a lower 30% to 50% of the length of the dispenser body. The at least one container engaging element is substantially rigid such that the dispenser body is relatively less squeezable along portions of the dispenser body that include the at least one container engaging element.

When assembled and ready for use, the contents of the flexible container are dispensed upon squeezing of the dispenser body as described above. Advantageously, as the contents to be dispensed are located within the flexible container, the contents do not contact the dispenser body. Additionally, during dispensing, the contents of the flexible container do not contact the dispenser body as the dispensing opening is located in the at least one container engaging element. This arrangement avoids the need for regular washing and cleaning of the dispenser body.

The at least one container engaging element preferably has a substantially circular cross-section at least at one end thereof, and has a substantially semi-circular cross-section at an opposite end thereof. The at least one container engaging element is preferably substantially tubular in overall form.

In a preferred embodiment, the dispenser comprises a first container engaging element and a second container engaging element. The first container engaging element is preferably at least partially receivable within the second container engaging element, and is preferably removably connectable thereto. In another embodiment, the first and second container engaging elements may be connected by a suitable hinge. In combination, the first and second container engaging elements are configured to engage a majority of the internal wall of the flexible container to thereby maintain the internal wall in a predetermined position. This arrangement ensures that substantially all of the contents of the flexible container are dispensed by promoting inversion of the flexible container within itself as its contents are dispensed. Thus, the contents cannot be located in folds, creases, or pleats in the walls of the flexible container.

In a preferred embodiment, the first and second container engaging elements are generally similar in form and have a substantially circular cross-section at a lower end thereof and have a substantially semi-circular cross-section at an opposite upper end thereof. The first and second container engaging elements are also preferably substantially tubular in overall form. The first container engaging element is preferably smaller in overall circumference when compared to the second container engaging element, so as to allow the first container engaging element to be at least partially receivable within the second container engaging element. The second container engaging element is preferably substantially open at its lower end to thereby receive the first container engaging element therethrough. The first container engaging element preferably includes the dispensing opening at its lower end. In an alternative embodiment, the first and second container engaging elements have a substantially semi-circular cross-section at an upper and lower end thereof. In such an embodiment, the first and second container engaging elements preferably have substantially the same arc length.

In an embodiment, the first container engaging element and the second container engaging element are configured to be arranged generally opposite one another when engaging the flexible container in order to maintain at least the portion of the flexible container in the predetermined position.

The first container engaging element is preferably moveable with respect to the second container engaging element between a first, partially engaged, position and a second, fully engaged, position. Preferably, the first container engaging element is rotatable between the first and second positions. In the first, partially engaged, position, at least one of the first and second container engaging elements is configured to at least partially engage at least a wall, preferably the internal wall, of the flexible container when received therein. In the second, fully engaged position, the first and second container engaging elements are configured to engage, in combination, generally opposed portions of the wall of the flexible container when received therein. Preferably, in the second, fully engaged, position, the first and second container engaging elements are configured to engage, in combination, a majority of the internal wall of the flexible container when received therein. Preferably, in the first position, the at least one of the first and second container engaging elements engages approximately 50% of the internal wall of the flexible container when received therein. Preferably, in the second position, the first and second container engaging elements, in combination, engage approximately 100% of the internal wall of the flexible container when received therein.

In the first, partially engaged, position, the upper ends of each of the first and second container engaging elements are preferably arranged generally adjacent one another. In the second, fully engaged, position, the first container engaging element is rotated approximately 180° with respect to the second container engaging element from the first position such that the upper ends of the first and second container engaging elements are arranged generally opposite one another. In this position, internal faces of the upper ends of the first and second container engaging elements generally face one another.

The contents of the flexible container is preferably substantially liquid or colloidal in form and is generally relatively flowable, although the invention is not limited to the form of the contents to be dispensed. For example, the contents may be solid particulate matter, which would be readily dispensable by the dispenser disclosed herein.

In a second aspect, the present invention provides a dispenser comprising a first container engaging element and a second container engaging element movable with respect to one another, the first and second container engaging elements adapted to engage a flexible container containing contents to be dispensed, wherein the first and second container engaging elements are configured to be arranged generally opposite one another when engaging the flexible container in order to maintain at least a portion of the flexible container in a predetermined position, wherein the contents of the flexible container are dispensed upon pressure being applied to the flexible container.

It will be appreciated that various independent features of the dispenser have been outlined above, but it is envisaged that any combination of individual features may be incorporated into the dispenser of the present invention.

As used herein, except where the context requires otherwise, the term “comprise” and variations of the term, such as “comprising”, “comprises” and “comprised”, are not intended to exclude further additives, components, integers or steps.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1 is an exploded view of a dispenser according to an embodiment of the invention;

FIG. 2 is a side view of the dispenser of FIG. 1 shown in an assembled configuration;

FIG. 3A is a side view of first and second container engaging elements of the dispenser of FIG. 1;

FIG. 3B is a perspective view of the first and second container engaging elements shown in FIG. 3A, and further shows a base of the dispenser of FIG. 1;

FIG. 3C is similar to FIG. 3B;

FIG. 3D is a side view of the components shown in FIG. 3C, and further shows the first and second container engaging elements being located within a flexible container;

FIG. 3E is similar to FIG. 3D, and further shows the first and second container engaging elements and flexible container being inserted into the dispenser body;

FIG. 4 is a side cutaway view of a lower end of the dispenser of FIG. 2;

FIG. 5 is a side cutaway view of the dispenser of FIG. 2;

FIG. 6 is similar to FIG. 5, but with the flexible container in a collapsed state;

FIG. 7A is a perspective view of the first and second container engaging elements in a first, partially engaged, position in which the container engaging elements are configured to partially engage the flexible container when received therein;

FIG. 7B is a perspective view of the first and second container engaging elements in a second, fully engaged, position in which the container engaging elements are configured to engage a majority of the flexible container when received therein;

FIG. 8 is a perspective view of the first and second container engaging elements and the base;

FIG. 9 is a perspective sectional view of an upper end of the dispenser of FIG. 1;

FIG. 10A is a perspective view of the first and second container engaging elements in a second, fully engaged, position with a seal of rectangular cross-sectional profile;

FIG. 10B is a perspective view of the first and second container engaging elements in a second, fully engaged, position with a seal of L-shaped cross-sectional profile;

FIG. 10C is a perspective view of the first and second container engaging elements in a second, fully engaged, position with a seal of elongated L-shaped cross-sectional profile;

FIG. 11 is a perspective view of a dispenser of another embodiment of the invention having a duckbill type valve at an upper end thereof; and

FIG. 12 is a perspective sectional view of the upper end of the dispenser of FIG. 11.

### DETAILED DESCRIPTION OF THE EMBODIMENTS

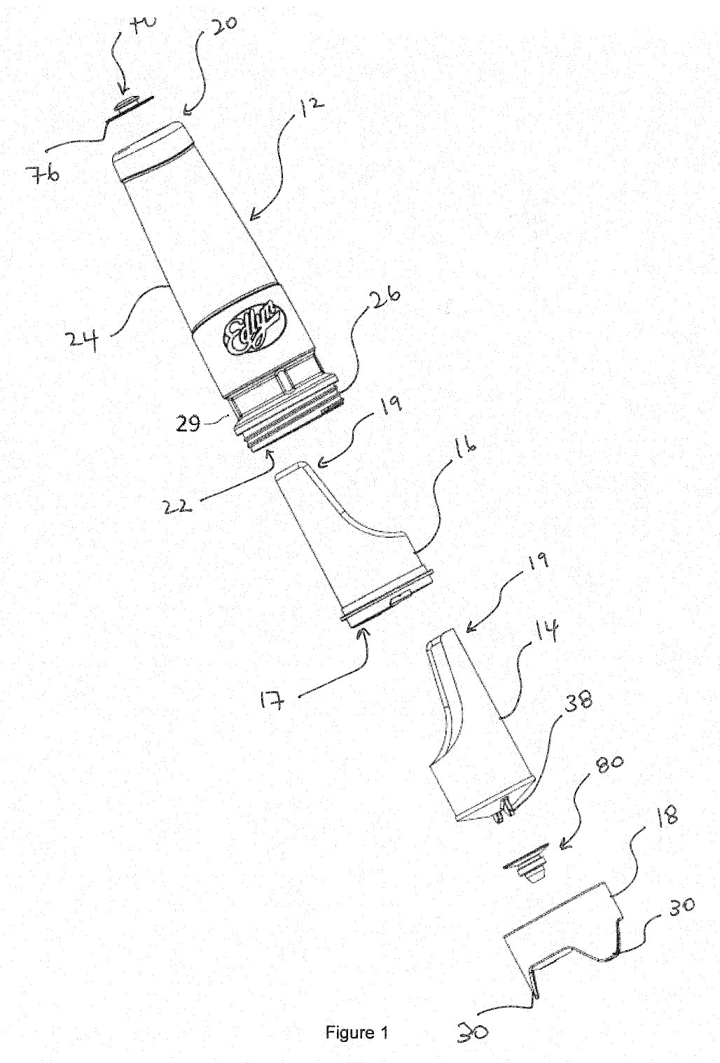

Referring to FIG. 1, there is shown an exploded view of a dispenser 10 according to an embodiment of the invention. The dispenser 10 is in the form of a squeezable bottle adapted to dispense condiments, such as ketchup, sauce, mustard, mayonnaise, salad dressing, and the like, albeit the invention is not limited to such applications.

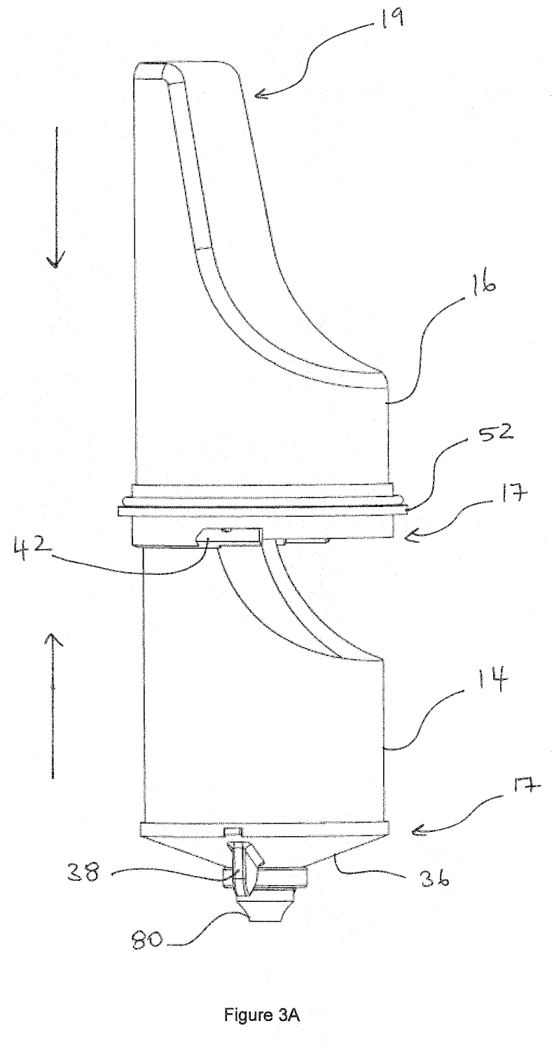

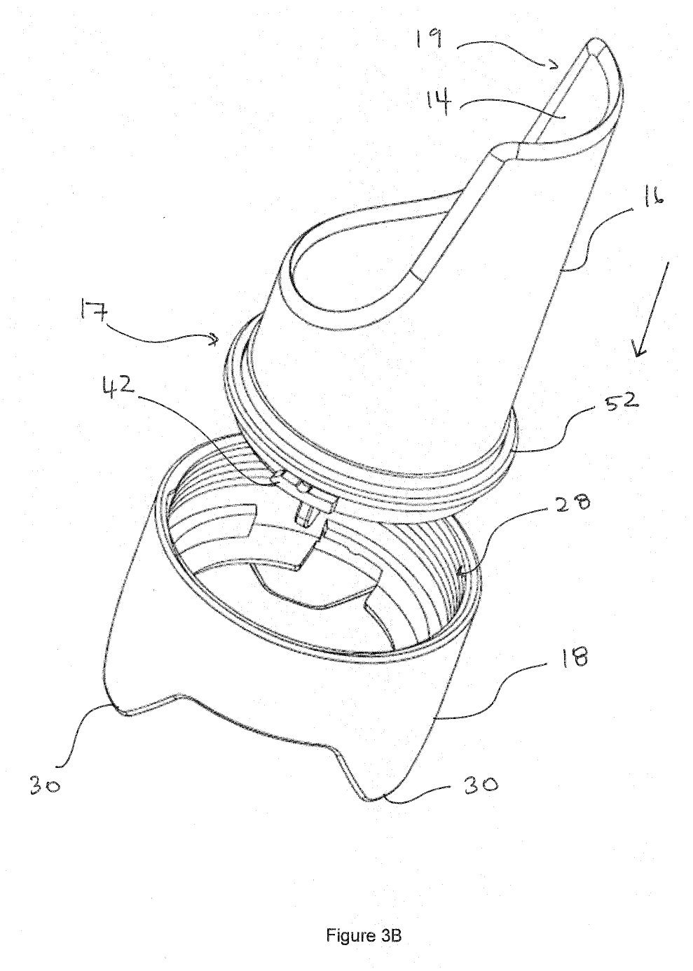

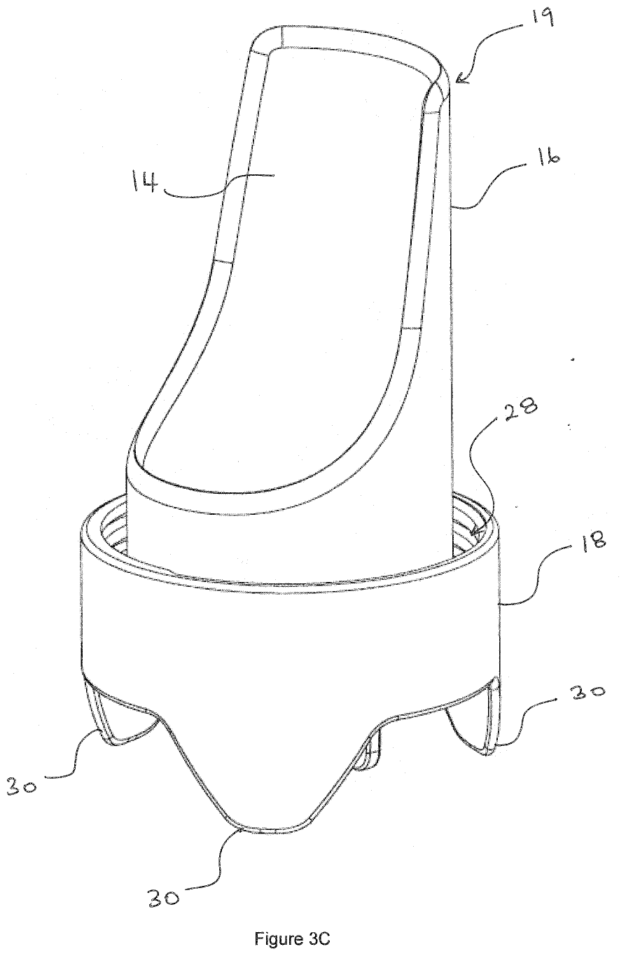

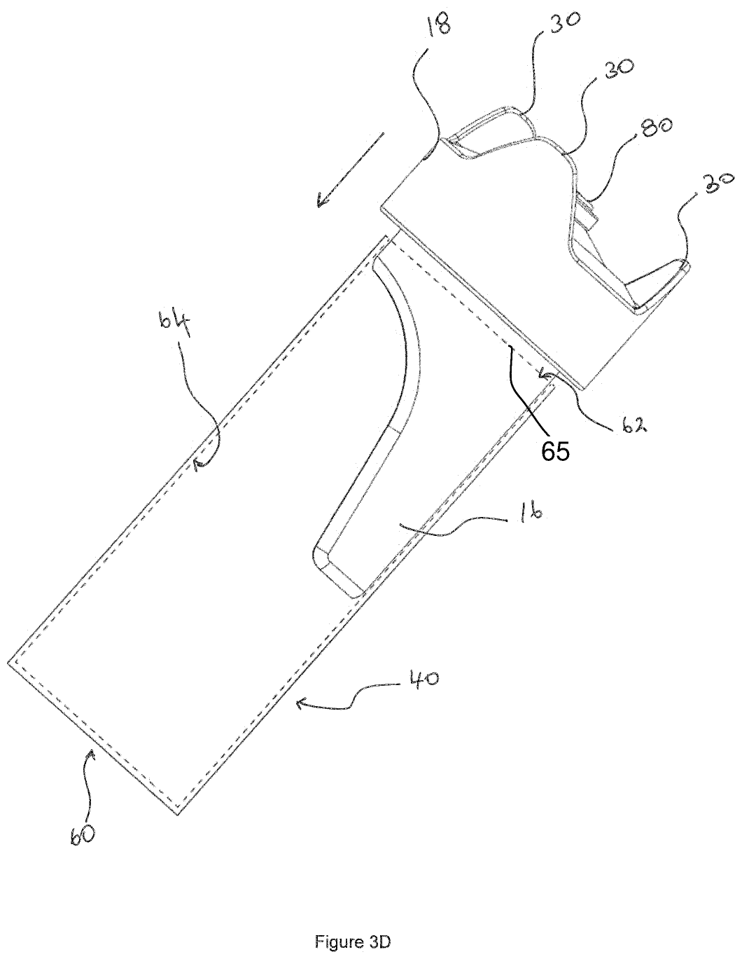

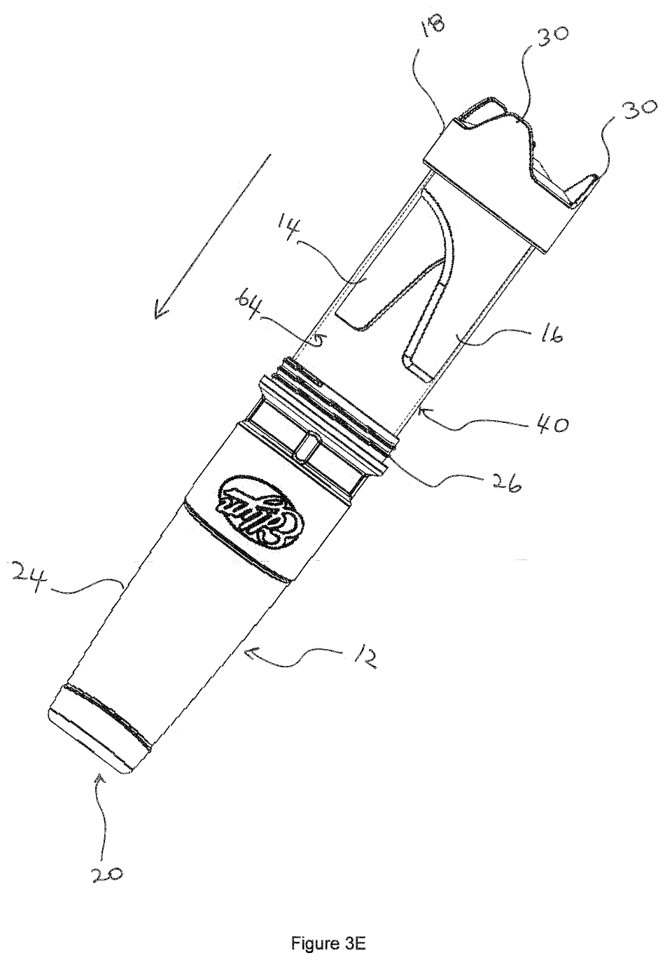

The dispenser 10 includes a dispenser body 12, first and second container engaging elements 14, 16 respectively, and a base 18. The first and second container engaging elements 14, 16 are removably receivable within an internal space defined by the dispenser body 12. As is explained below, the first and second container engaging elements 14, 16 are adapted to engage a flexible container 40 (FIG. 3D) removably received within the internal space. The flexible container 40 contains contents to be dispensed, such as sauce, mustard, and the like.

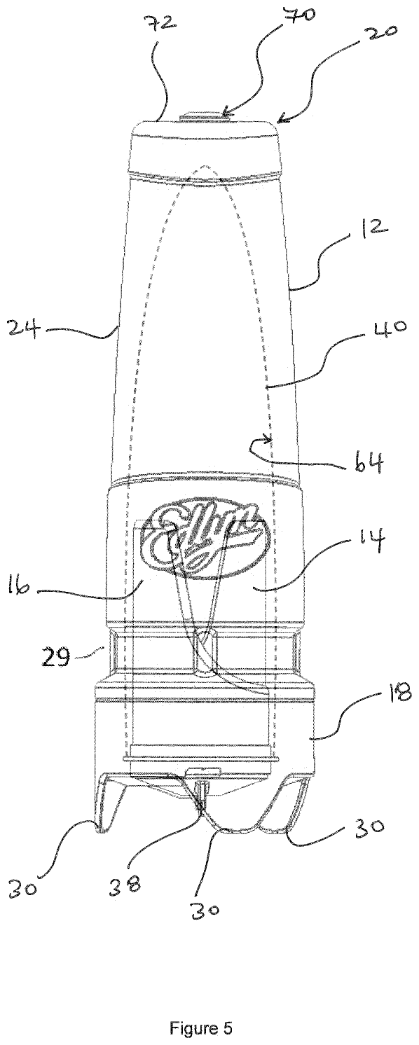

The flexible container 40 is intended to be disposed of after use, that is after substantially all or all of its contents has been dispensed. In the manner described below, the flexible container 40 is deformable and collapsible upon squeezing on the dispenser body 12 to thereby assist with dispensing the contents of the flexible container 40. Referring to FIG. 3D, the flexible container 40 may be in the form of a pouch, or a bag, or a liner, and typically includes a closed end 60, and an opposite openable end 62. The openable end 62 may include perforations, indentations, or the like to assist a user with removing a portion of the openable end 62 to thereby open the flexible container 40. Once opened, the first and second container engaging elements 14, 16 may be inserted into the flexible container 40. As is shown throughout the figures, the flexible container 40 is elongate in overall form and includes a generally circular cross-section at least near its openable end 62. The flexible container 40 is dimensioned so as to be removably receivable within the dispenser body 12, as is shown in FIG. 5 for example (the flexible container 40 being shown in dotted outline).

The first and second container engaging elements 14, 16 are configured to maintain at least a portion of the flexible container 40 in a predetermined position. Specifically, once received within the flexible container 40, the first and second container engaging elements 14, 16 engage at least an internal wall 64 of the flexible container 40 to maintain the internal wall in a predetermined position. The predetermined position corresponds to a substantially open position of the flexible container 40, and preferably one in which there are no folds, creases, or pleats in the internal wall in which a portion of the contents of the flexible container may be located or trapped. Advantageously, this ensures that substantially all or all of the contents of the flexible container 40 will be dispensed during use.

Referring to FIG. 1, it can be seen that the dispenser body 12 is substantially tubular in overall form, and includes a partially closed upper end 20, an opposite open lower end 22, and a sidewall 24 located therebetween. The internal space is defined within the dispenser body 12 between the sidewall 24 and the closed and open ends 20, 22.

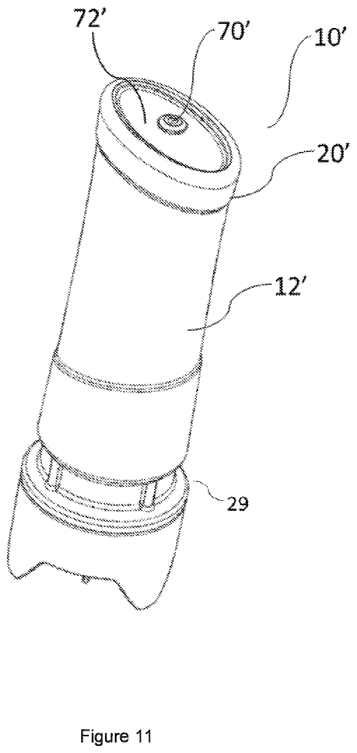

The sidewall 24 is substantially elliptical in cross-section at the upper end 20 and transitions into having a substantially circular cross-section at the lower end 22. As best shown in FIG. 11, the substantially elliptical cross-section at the upper end 20 of the dispenser body 12 lies in a plane that is angled relative to the plane in which the substantially circular cross-section at the lower end 22 of the dispenser body 12 lies. In this way, the overall ergonomic form of the dispenser body 12 is enhanced by providing greater leverage when squeezed by a user near the upper end 20. Sidewall 24 includes a section of reduced circumference towards the lower end 22, namely grooved section 29. Grooved section 29 includes a plurality of projections 27 arranged equidistantly about a circumference of the grooved section 29. An inner side of each projection 27 defines at least in part a channel (not shown) within the dispenser body 12. The importance of grooved section 29 and projections 27 will be discussed in greater detail later. The sidewall 24 is resiliently deformable such that the sidewall 24 may be squeezed relatively inwardly, and return to its original shape once squeezing pressure on the sidewall 24 has been released. The dispenser body 12 may be made from a material such as high-density polyethylene (HDPE) or low-density polyethylene (LDPE). However, a person skilled in the art would appreciate that a variety of alternative generally flexible materials would be suitable for forming the dispenser body 12. Furthermore, a person skilled in the art would appreciate that the shape and dimensions of the dispenser body 12 are merely exemplary, and that a variety of alternative shapes and dimensions may be used in the present invention.

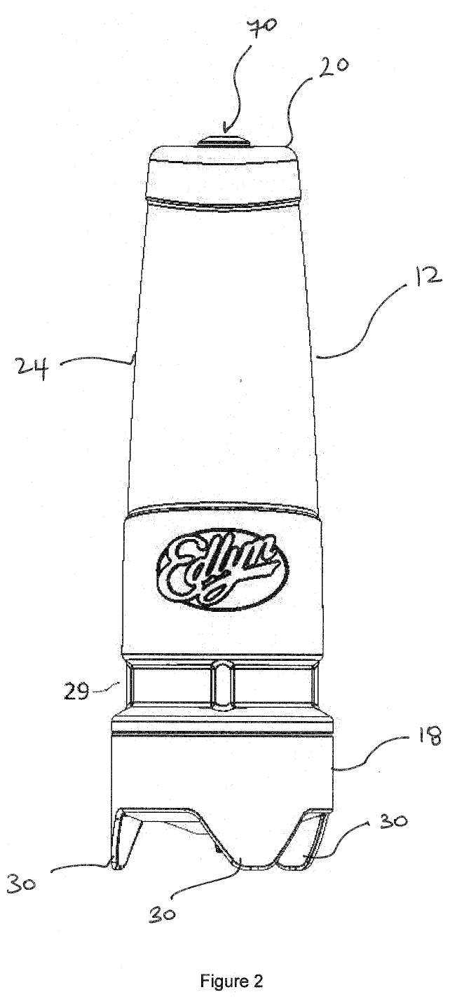

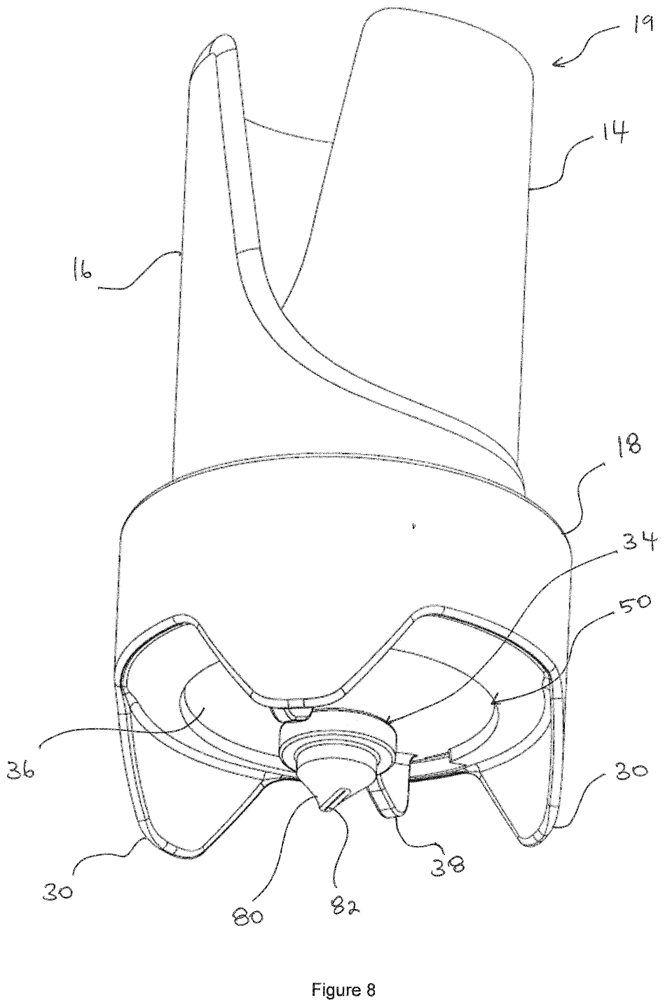

In the embodiment illustrated, the dispenser body 12 includes a thread 26 on an external surface thereof adjacent the lower end 22. The thread 26 is configured to engage with a corresponding thread 28 (FIG. 3B) located on an internal surface of the base 18, such that the base 18 is rotatably connectable to the dispenser body 12 to thereby secure the base 18 to the dispenser body 12. As is shown in FIGS. 2 and 8 in particular, the base 18 is substantially circular in cross-section and includes three generally trapezoidal extensions 30 at a lower end thereof that extend generally parallel to a longitudinal axis of the base 18, and which are configured to contact a surface to allow the container 10 to rest upon the surface. The three generally trapezoidal extensions 30 are arranged equidistantly about a circumference of the base 18 to provide stability. The base 18 comprises a relatively more rigid material when compared to the dispenser body 12. In one embodiment, the base 18 may be made from polypropylene (PP), albeit a person skilled in the art would appreciate that a variety of alternative generally rigid materials would be suitable for forming the base 18.

Referring to FIGS. 3A and 3B in particular, it can be seen that each of the first and second container engaging elements 14, 16 have a substantially circular cross-section at a lower end 17 thereof and transition into having a substantially semicircular cross-section at an opposite upper end 19 thereof (see FIG. 3B in particular). The first and second container engaging elements 14, 16 are also substantially tubular in overall form. As is shown in these figures, the first container engaging element 14 is partially receivable within the second container engaging element 16 so as to be removably connectable thereto. Specifically, the first container engaging element 14 is slightly smaller in overall circumference as compared to the second container engaging element 16, such that the second container engaging element 16 is slidable over the first container engaging element 14 in the manner illustrated in FIG. 3A (the arrows in this figure indicating the relative sliding directions of the first and second container engaging elements 14, 16).

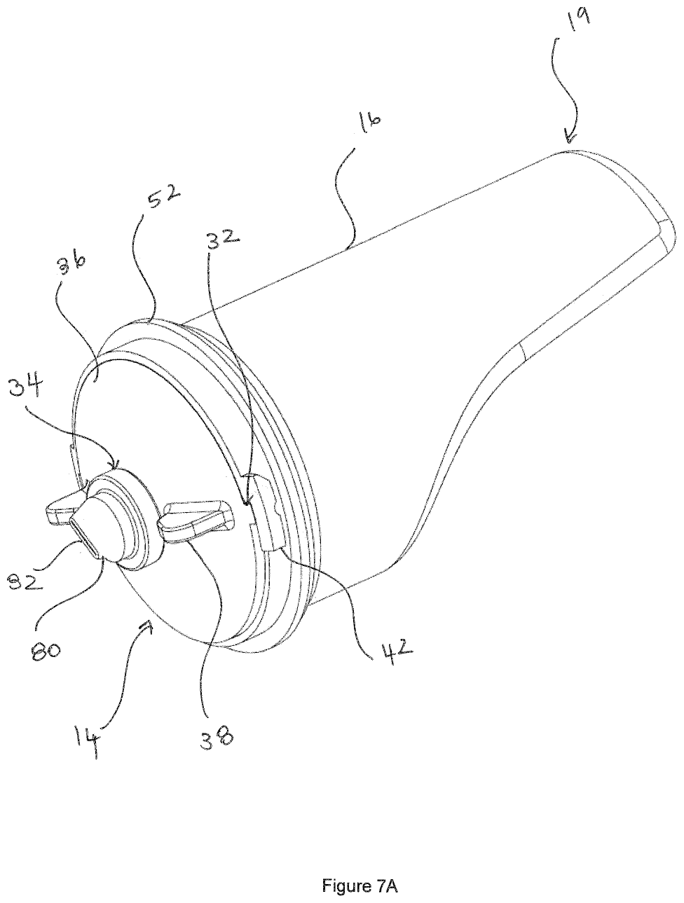

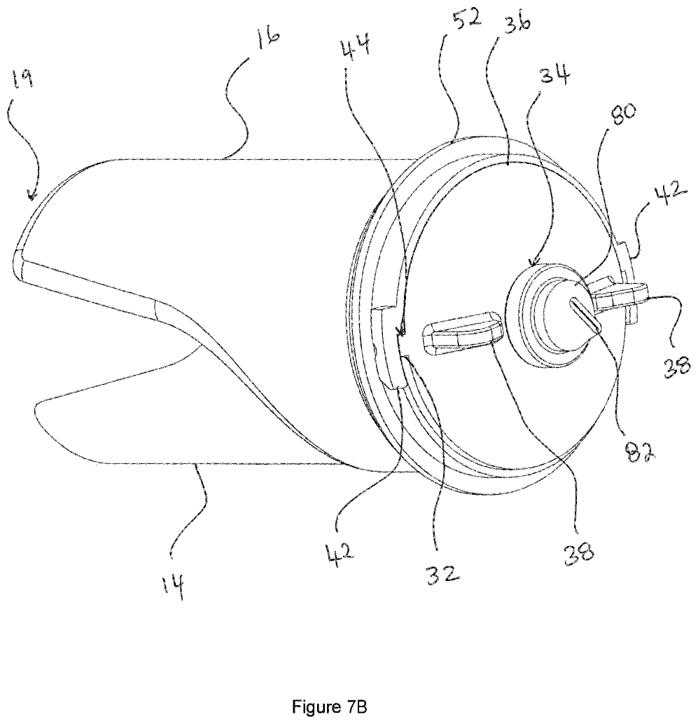

The second container engaging element 16 is slidable over the first container engaging element 14 until a surface of the second container engaging element 16 contacts a detent 32 (FIG. 7A) that projects radially outwardly from the lower end 17 of the first container engaging element 14. Although the circumference of the first container engaging element 14 is smaller than the circumference of the second container engaging element 16, the circumferences are nonetheless similar such the first and second container engaging elements 14, 16 may be frictionally fit with respect to one another in the position shown in FIG. 3B. Similar to the base 18, the first and second container engaging elements 14, 16 comprise a relatively more rigid material when compared to the dispenser body 12. For example, the first and second container engaging elements 14, 16 may be made from polypropylene (PP), albeit a person skilled in the art would appreciate that a variety of alternative generally rigid materials would be suitable for forming these elements.

As will be appreciated, the second container engaging element 16 is open at its lower end 17 to be able to slidably receive the first container engaging element 14 at least partially therein. However, the first container engaging element 14 is dissimilar to the second container engaging element 16 in that it includes a generally closed lower end, but for a substantially circular dispensing opening 34 (see FIGS. 7A, 7B and 8 in particular) centrally located in a substantially circular lower face 36 thereof. The lower face 36 is part bowl-shaped.

The dispensing opening 34 includes a one-way valve 80 that is configured to receive and dispense the contents of the flexible container 40 therethough, but prevents air from entering the flexible container 40 via the valve 80. As is shown in FIG. 7A for example, the valve 80 includes an opening 82 through which the contents of the flexible container 40 are dispensed. The opening 82 is biased to a closed position (illustrated in FIG. 7A), and is selectively opened when pressure is applied to the flexible container 40 to dispense its contents.

The one-way valve 80 may be in the form of a duckbill valve, or any other valve that is considered suitable by a person skilled in the art. Advantageously, the valve 80 is interchangeable with another valve (not shown) that may provide different flow characteristics, such as a different flow rate. Preferably, the form of the valve is selected depending upon the characteristics of the contents to be dispensed, such as the viscosity of the fluid.

As is shown in FIG. 8, the base 18 includes a substantially circular opening 50 in a lower end face thereof that is relatively larger than the dispensing opening 34 such that, when the first and second container engaging elements 14, 16 are coupled to the base 18 in the manner described below, contents dispensed through the valve 80 do not contact the base 18. It should be appreciated that the valve 80 forms the opening through which the contents of the flexible container 40 is dispensed from the dispenser 10. In other words, there is no other opening in the dispenser body 12 or base 18 through which the contents passes before being dispensed.

Referring now to FIGS. 7A and 7B, it can be seen that the first container engaging element 14 is rotatable with respect to the second container engaging element 16 between a first, partially engaged, position (FIG. 7A) and a second, fully engaged, position (FIG. 7B). In the first, partially engaged, position, the second container engaging element 16 is configured to partially engage the internal wall 64 of the flexible container 40 when received therein. Specifically, the second container engaging element 16 engages approximately 50% of the internal wall 64 of the flexible container 40 when received therein. In the second, fully engaged position, the first and second container engaging elements 14, 16 are configured to engage a majority of the internal wall 64 of the flexible container 40 when received therein (as is shown in FIG. 3E for example). Specifically, the first and second container engaging elements 14, 16, in combination, engage approximately 100% of the circumference of the lower portion of internal wall of the flexible container when received therein in the fully engaged position. Advantageously therefore, in the second, fully engaged position, the first and second container engaging elements 14, 16 engage and maintain the internal wall 64 of the flexible container in the predetermined position, thereby ensuring that substantially all or all of the contents of the flexible container 40 will be dispensed during use, as is explained below.

As is shown in FIGS. 7A and 7B, the lower face 36 of the first container engaging element 14 includes a pair of generally trapezoidal tabs 38 disposed on opposite sides of the dispensing opening 34 and valve 80 and which project from the lower face 36 in a direction generally parallel to a longitudinal axis of the first container engaging element 14. Each of the tabs 38 are graspable to rotate the first container engaging element 14 with respect to the second container engaging element 16 about the longitudinal axis from the first, partially engaged, position (FIG. 7A) to the second, fully engaged, position (FIG. 7B). The second position is approximately 180° from the first position. As is shown in FIG. 8, the opening 50 in the base 18 is large enough such that the tabs 38 extend therethrough to be graspable.

The second container engaging element 16 includes a pair of opposing lateral flanges 42 (FIG. 7A) disposed at the lower end 17 thereof, and that project generally radially outwardly and extend along a portion of a lower circumference of the second container engaging element 16. Each of the flanges 42 include a portion 44 that is engaged by the detent 32, such that the flanges 42 define a rotational limit of the first container engaging element 14 with respect to the second container engaging element 16. Specifically, as is shown in FIGS. 7A and 7B, the first container engaging element 14 may be rotated approximately 180° with respect to the second container engaging element 16 about the longitudinal axis to thereby selectively move the first and second container engaging elements 14, 16 between the first, partially engaged, position (FIG. 7A) and the second, fully engaged position (FIG. 7B).

The method of assembling the container 10 will now be described by reference to the figures. Referring to FIG. 3A initially, as is described above, the first and second container engaging elements 14, 16 are firstly removably connected to one another by relatively sliding the first container engaging element 14 within the second container engaging element 16 in the direction of the arrows. Next, with reference to FIG. 3B, the base 18 is secured to the combined first and second container engaging elements 14, 16 by relatively rotating the base 18 with respect to the combined elements 14, 16 until the lateral flanges 42 (FIG. 7A) on the second (or outer) container engaging element 16 engage within a slot (not shown) in the base 18. The combined container engaging elements 14, 16 are now releasably secured to the base 18 in the manner shown in FIG. 3C.

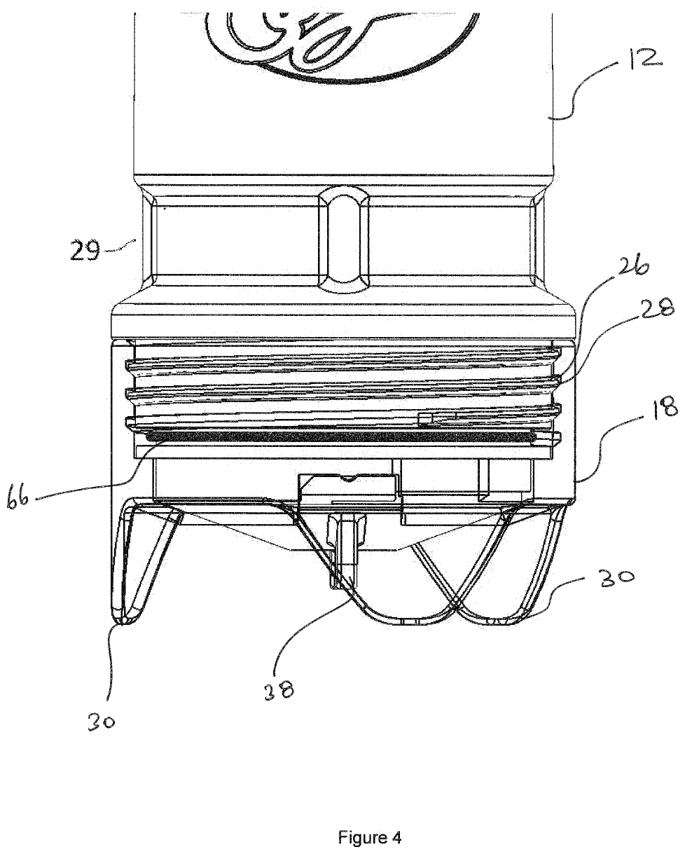

Next, with reference to FIG. 3D, the combined base 18 and container engaging elements 14, 16 are inserted into the opened end 62 of the flexible container 40 via their upper ends 19. Specifically, the first and second container engaging elements 14, 16 are inserted into the flexible container 40 until a lower edge 65 of the wall 64 of the flexible container 40 is contacted circumferentially by the outer wall of second container engaging element 16 near the lower end 17 thereof. This produces a relatively tight fit between the flexible container 40 and the second engaging element 16. It is noted that an O-ring seal 66 is also provided as shown in FIG. 4. The O-ring seal 66 is circumferentially disposed about the second container engaging element 16 near the lower end 17 thereof above the circumferential flange 52.

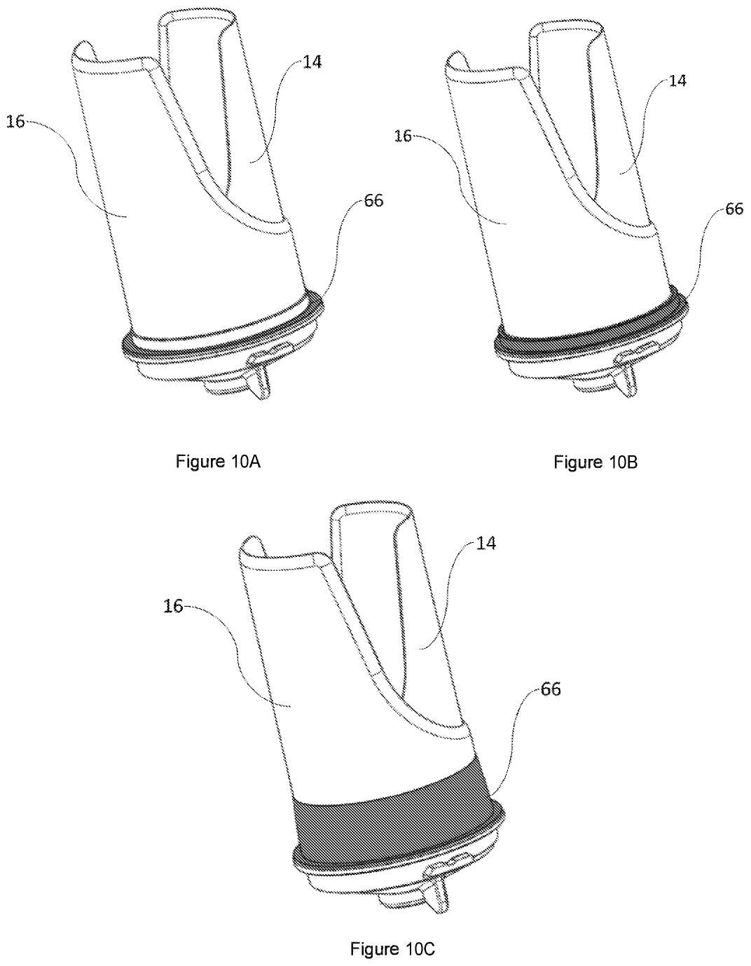

In some embodiments, it is not desirable from a performance perspective for flexible container 40 to contact O-ring seal 66. Thus, insertion of the first and second container engaging elements 14, 16 into the flexible container 40 should fall short of the O-ring seal 66 (but ensure sufficient contact circumferentially by the outer wall of second container engaging element 16 with the lower edge 65 of the wall 64 of the flexible container 40. It is noted that O-ring seal 66 has a circular cross-section profile. However, seal 66 can have any other suitable cross-section profile. Some examples are provided in FIGS. 10A-C. Seal 66 of FIG. 10A has a rectangular profile, seal 66 of FIG. 10B has an L-shaped profile, and seal 66 of FIG. 100 has an elongated L-shaped profile. In an embodiment that utilises the seal 66 of FIG. 10C, such a seal may be configured to extend into flexible container 40 and engage with wall 64 thereof. In such a case, seal 66 would provide a seal between the flexible container 40 and the second engaging element 16. Seals 66 can be provided as a separate removable component, or be permanently affixed to the second container engaging element 16 (e.g. by over moulding).

Next, the first container engaging element 14 is rotated with respect to the second container engaging element 16 such that the elements 14, 16 move from the first, partially engaged, position (FIGS. 3D and 7A) to the second, fully engaged position (FIGS. 3E and 7B). As is explained above, the first container engaging element 14 is rotated with respect to the second container engaging element 16 by grasping and pulling on at least one the tabs 38 extending from the closed lower end of the first container engaging element 14. In the position illustrated in FIG. 3E, the first and second container engaging elements 14, 16 engage a majority of the circumference of the lower portion of the internal wall of the flexible container 40 to thereby maintain the flexible container in its predetermined open position.

Lastly, with reference to FIG. 3E, the combined base 18, container engaging elements 14, 16, and flexible container 40 are inserted into the internal space of the dispenser body 12. The base 18 is then secured to the dispenser body 12 by relatively rotating the base 18 with respect to the dispenser body 12 such that the external thread 26 located on the dispenser body 12 threadably engages the internal thread 28 located within the base 18. As is shown in FIG. 4, continued rotation of the base 18 with respect to the dispenser body 12 results in engagement of the O-ring seal 66 by the dispenser body 12, base 18 and container engaging element 16, thereby together imparting a compressive load to the O-ring 66 and creating a fluidic seal of the internal space of the dispenser body 12. This compression of the O-ring 66 also ensures that the O-ring 66 is operatively retained within the dispenser 10. Advantageously, in this position, the lower edge 65 of the wall 64 of flexible container 40 (not shown in FIG. 4) and the contacting outer wall of second engaging element 16 are engaged by the grooved section 29. This engagement by grooved section 29 is what ensures that engagement between the flexible container 40 and the outer wall of the second container engaging element 16 is maintained, as well as ensuring that the first and second container engaging elements 14, 16 maintain the dispensing body 12 in shape while the dispensing body 12 is being squeezed. Absent grooved section 29, there is a risk over time that the flexible container 40 could slide up and potentially out of engagement with the first and second container engaging elements 14, 16. Further, the channels (defined by the inner side of projections 27 inside the dispenser body 12) are configured to provide a passage for air away from the internal space of the dispenser body 12 when the dispenser body 12 is being assembled with the base 18, e.g. when the flexible container 40 is being received in the dispenser body 12 and/or when the base 18 and dispenser body 12 are being rotatably engaged. The channels ensure that air can move away from the internal space of the dispenser body 12 and prevent any inadvertent application of pressure on the flexible container 40 during assembly. Such pressure could otherwise lead to premature dispensing of the contents from the flexible container 40 during assembly. This ensures that the flexible container 40 remains in the predetermined position, and that none of the contents of the flexible container 40 leak past the O-ring seal 66 between the first and second container engaging elements 14, 16 and the dispenser body 12.

When assembled, the dispenser 10 is able to rest on a surface via the base 18, with the extensions 30 positioning the dispensing opening 34 above the surface so as not to contaminate the valve 80, as is generally shown in FIGS. 2 and 5 for example. In the position shown in FIG. 5, the flexible container 40 (shown in dotted outline) is in a generally inverted orientation with the dispensing opening 34 and valve 80 generally facing the surface. Additionally, the first and second container engaging elements 14, 16 extend from the base 18 generally upwardly within the dispenser body 12 so as to be generally adjacent an inner side wall of the dispenser body 12. The first and second container engaging elements 14, 16 are substantially rigid such that the dispenser body 12 is relatively less squeezable along portions of the dispenser body 12 that include the first and second container engaging elements 14, 16.

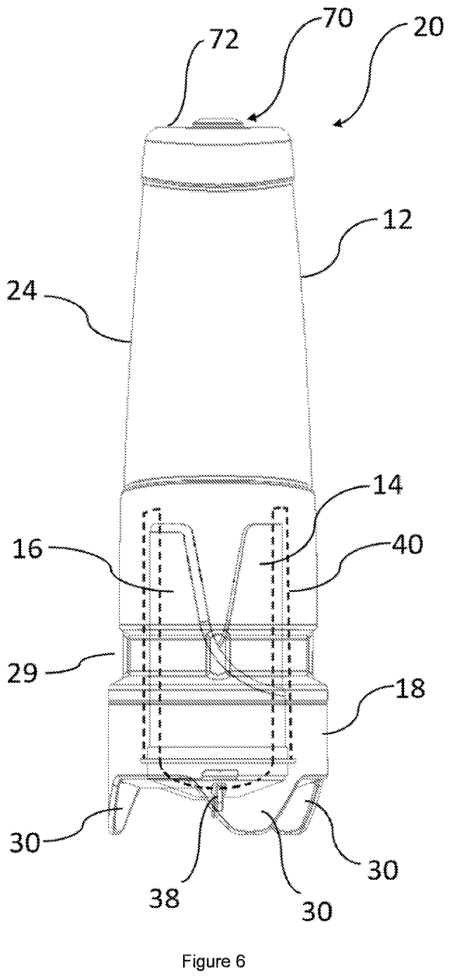

The first and second container engaging elements 14, 16 extend within the flexible container 40 within a range of between approximately 30% to 50% of the overall length of the flexible container 40. Advantageously, this range of extension within the flexible container 40 allows for 50% or more of the length of the flexible container 40 to be relatively deformable, collapsible, and eventually invertible, as the contents of the flexible container 40 is dispensed during use. The first and second container engaging elements 14, 16 promote this inversion of the flexible container 40 within itself as its contents are dispensed, thereby substantially preventing contents being located in folds, creases, or pleats in the walls of the flexible container 40. Specifically, this range of extension of the first and second container engaging elements 14, 16 allows the closed end 60 of the flexible container 40 to descend into a bowl-shaped cavity defined by the first and second container engaging elements 14, 16 near the lower face 36 of the first container engaging element 14 (as is generally shown in FIG. 6). Moreover, the range of extension of the first and second container engaging elements 14, 16 allows the closed end 60 of the flexible container 40 to extend below the position of the circumferential flange 52 to thereby ensure that all or substantially all of the contents of the flexible container 40 are dispensed during use when the container engaging elements 14, 16 are in the second, fully engaged, position.

It will be appreciated that, in combination, the first and second container engaging elements 14, 16 engage a majority of the internal wall 64 of the flexible container 40 when in the second, fully engaged position (FIGS. 3E, 5 and 6) to thereby maintain the internal wall 64 in the predetermined open position. Specifically, the shape of at least portions of the first and second container engaging elements 14, 16 substantially conform to the shape of the internal wall 64 of the flexible container 40. Advantageously, this arrangement along with the abovementioned range of extension of the elements 14, 16 within the flexible container 40 ensures that substantially all or all of the contents of the flexible container 40 are dispensed during use. Additionally, the first and second container engaging elements 14, 16 substantially prevent the formation of folds, creases, or pleats in the wall 64 of the flexible container 40 in which some of the contents of the container 40 may be located or trapped.

As is explained above, when assembled and ready for use, the contents of flexible container 40 are dispensed upon squeezing of the dispenser body 12. Advantageously, as the contents to be dispensed are located within the flexible container 40, the contents do not contact the dispenser body 12. Additionally, during dispensing, the contents of flexible container 40 do not contact the dispenser body 12 as the dispensing opening 34 is located in the first container engaging element 14. This arrangement avoids the need for regular washing and cleaning of the dispenser body 12. Additionally, as is explained above, the opening 50 in the base 18 is relatively larger than the dispensing opening 34 (as shown in FIG. 8), such that the contents of the flexible container 40 also do not contact the base 18 during use. Advantageously, this arrangement also avoids the need for regular washing and cleaning of the base 18.

After the contents of the flexible container 40 have been dispensed, the dispenser 10 may be disassembled by simply disconnecting the base 18 from the dispenser body 12, by relatively rotating the base 18 with respect to the dispenser body 12. Thereafter, the flexible container 40 can be removed, generally by pulling the flexible container 40 away from the combined base 18 and container engaging elements 14, 16. The flexible container 40 may then be disposed of. A new flexible container may then be opened, and the combined base 18 and container engaging elements 14, 16 may be inserted therein. Optionally, the container engaging elements 14, 16 may be washed before being inserted into the new flexible container. The combined base 18, container engaging elements 14, 16, and new flexible container may then be inserted into the dispenser body 12 in the manner described above for use.

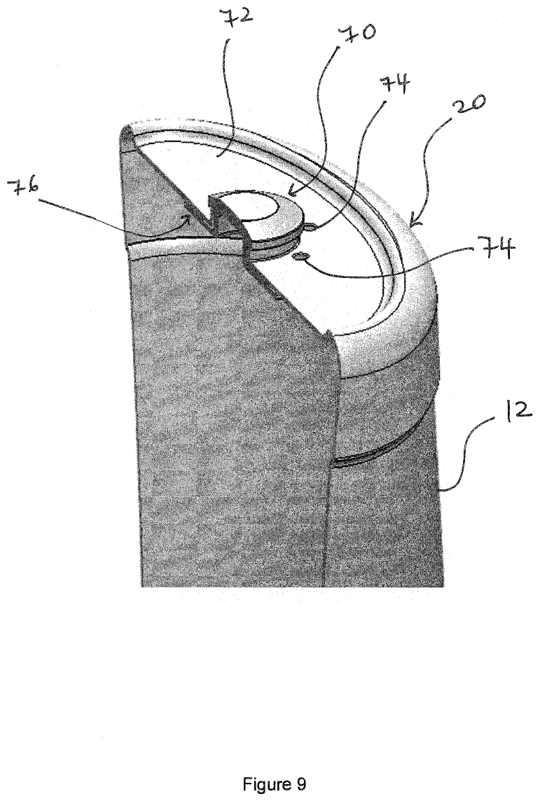

The dispenser 10 also includes a one-way air valve 70 (see FIGS. 1 and 9 for example). The one-way air valve 70 is located in an upper surface 72 of the dispenser body 12 at the upper end 20 thereof. The one-way air valve 70 is in the form of an umbrella type valve, however other suitable valves may be used. Under certain conditions, the one-way air valve 70 is configured to prevent air from exiting the internal space of dispenser body 12 via a plurality of generally circular air inlet holes 74 (FIG. 9) located in the upper surface 72.

As is shown in FIG. 9, the one-way valve 70 comprises a generally circular disc 76 that is located within the internal space of the dispenser body 12 and that is movably suspended to the upper surface 72. As the dispenser body 12 is squeezed relatively inwardly, the volume of the internal space decreases causing a corresponding increase in air pressure within the internal space. This increase in air pressure forces the circular disc 76 generally upwardly to thereby close the air inlet holes 74. Once the air inlet holes 74 are closed, air within the internal space is substantially prevented from exiting the dispenser body 12 via the air inlet holes 74 (the seal 66 located near the lower end of the dispenser body 12 also substantially prevents air from exiting the dispenser body 12 therethrough).

Accordingly, the one-way air valve 70 is configured to close upon squeezing of the dispenser body 12. The increase in air pressure within the internal space applies pressure to the flexible container 40 to thereby dispense its contents. Specifically, the increase in air pressure causes the flexible container 40 to deform, thereby forcing the contents of the flexible container 40 to be dispensed via the dispensing opening 34. As the contents of the flexible container 40 are dispensed, a partial vacuum is formed within the flexible container 40. The increase in air pressure within the internal space of the dispenser body 12 coupled with the partial vacuum within the flexible container 40 causes the flexible container 40 to at least partially fold over or collapse into at least a portion of the first and second container engaging elements 14, 16 as is generally shown in FIG. 6 (in this figure, substantially all of the contents of the flexible container 40 have been dispensed). Once squeezing pressure on the dispenser body 12 has been released, the circular disc 76 of the one-way air valve 70 is allowed to descend to its usual position, thereby allowing air to be drawn into the dispenser body 12 via the air inlet holes 74 to thereby equalize the air pressure within the internal space whilst the flexible container 40 remains collapsed. The one-way valve 80 in the dispensing opening 34 prevents draw back of air into the flexible container 40.

Advantageously, the folding and collapsing of the flexible container 40 ensures that substantially all or all of the contents of the flexible container 40 are ultimately dispensed, thereby limiting wastage. As will be appreciated, in prior squeezable bottle designs, it is common for some of the contents of the squeezable bottle to be located on at least the internal walls of the squeezable bottle after the useful contents of the bottle has been dispensed, thereby contributing to wastage of the condiment.

Furthermore, as is described above, the dispenser 10 of the present disclosure avoids the need for regular washing of the dispenser body 12 and base 18. The dispenser 10 is thereby relatively environmentally friendly and sustainable when compared to prior squeeze bottle designs. Additionally, as the contents to be dispensed are located within a disposable flexible container 40, the dispenser 10 is readily reusable by simply replacing the flexible container as desired.

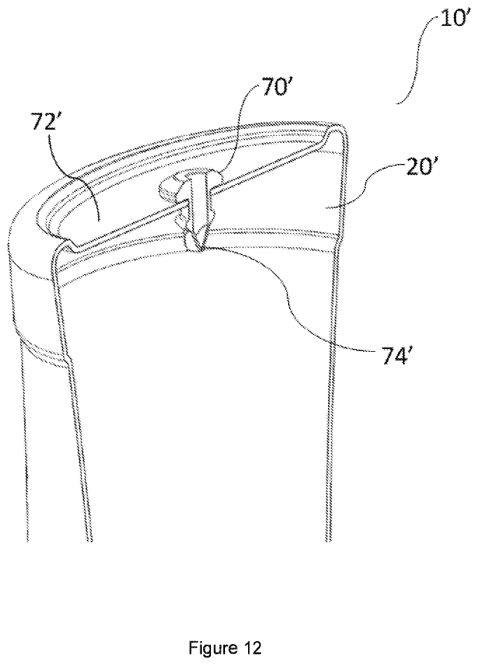

Reference is now made to FIGS. 11 and 12, which provide a dispenser 10′ in accordance with another embodiment of the invention. Dispenser 10′ is substantially the same as dispenser 10, except that dispenser 10′ includes a one-way air valve 70′ in the form of a duckbill type valve (similar to the valve 80). The duckbill valve 70′ is located in an upper surface 72′ of the dispenser body 12′ at the upper end 20′ thereof. Similar to one-way valve 80, duckbill valve 70′ is configured to prevent air from exiting the internal space of dispenser body 12′. As the dispenser body 12′ is squeezed relatively inwardly, the volume of the internal space decreases causing a corresponding increase in air pressure within the internal space. Duckbill valve 70′ is closed, therefore air within the internal space is substantially prevented from exiting the dispenser body 12′. Once squeezing pressure on the dispenser body 12′ has been released, the higher external pressure (atmospheric pressure) relative to the pressure in the internal space causes duckbill valve 70′ to open enough to allow air to be drawn into the dispenser body 12′ via the opening 74′ to thereby equalize the air pressure within the internal space whilst the flexible container remains collapsed. The one-way valve in the dispensing opening prevents draw back of air into the flexible container.

Using a duckbill valve 70′ has advantages over using an umbrella type valve 70. For example, umbrella type valve 70 requires the upper surface 72 (i.e. the sealing surface) of the dispenser body 12 to be flat in order for circular disc 76 to adequately close air inlet holes 74. It can be difficult to achieve this when manufacturing dispenser body 12 in, for example, a blow moulding process. Conversely, the use of duckbill valve 70′ does not require such accurately manufactured components, as the duckbill valves sealing function is self contained.

It will be understood that the invention disclosed and defined in this specification extends to all alternative combinations of two or more of the individual features mentioned or evident from the text or drawings. All of these different combinations constitute various alternative aspects of the invention.

1. A dispenser, comprising:
at least one container engaging element adapted to engage a flexible container containing contents to be dispensed, the at least one container engaging element including a dispensing opening configured to receive and dispense the contents of the flexible container through the dispensing opening; and
a base operatively associated with the at least one container engaging element and including an opening configured to receive the dispensing opening of the at least one container engaging element;
wherein the at least one container engaging element is configured to maintain at least a portion of the flexible container in a predetermined position, wherein the contents of the flexible container are dispensed upon pressure being applied to the flexible container.

2. The dispenser of claim 1, further comprising a resiliently deformable dispenser body defining an internal space for removably receiving the at least one container engaging element.

3. The dispenser of claim 1 or 2, wherein the base is configured to be connected to the at least one container engaging element.

4. The dispenser of claim 2 or 3, wherein the base is configured to be connected to the dispenser body.

5. The dispenser of any one of claims 2 to 4, further comprising a one-way valve configured to close upon squeezing of the dispenser body, thereby preventing air within the internal space from exiting via the one-way valve.

6. The dispenser of claim 5, wherein squeezing the dispenser body causes an increase in air pressure within the internal space, which increase in air pressure applies said pressure to the flexible container to thereby dispense its contents and causes the flexible container to at least partially fold over or collapse into at least a portion of the at least one container engaging element or a cavity defined by the at least one container engaging element.

7. The dispenser of any one of the preceding claims, wherein the at least one container engaging element is removably receivable at least partially within the flexible container.

8. The dispenser of claim 7, wherein the at least one container engaging element is configured to engage at least a wall of the flexible container to maintain the wall in a predetermined position when the at least one container engaging element is located at least partially within the flexible container.

9. The dispenser of any one of the preceding claims, wherein the dispensing opening includes a one-way valve configured to allow the contents of the flexible container to be dispensed therethrough, and further configured to prevent air from entering the flexible container from an environment external to the dispenser.

10. The dispenser of claim 4 or any one of claims 5 to 9 insofar as dependent thereon, further comprising a seal disposed about the at least one container engaging element, wherein the dispenser body is configured to engage the seal when the base is connected to the dispenser body, to thereby hermetically seal or substantially hermetically seal the internal space.

11. The dispenser of any one of the preceding claims, wherein the dispenser is configured to rest on a surface via the base such that the flexible container is in a generally inverted orientation with the dispensing opening and an opening of the flexible container generally facing the surface.

12. The dispenser of any one of the preceding claims, comprising a first container engaging element and a second container engaging element.

13. The dispenser of claim 12, wherein the first container engaging element is moveable with respect to the second container engaging element.

14. The dispenser of claim 12 or 13, wherein the first container engaging element and the second container engaging element are configured to be arranged generally opposite one another when engaging the flexible container in order to maintain at least the portion of the flexible container in the predetermined position.

15. The dispenser of claim 13 or 14 when dependent on claim 8, wherein the first container engaging element is moveable with respect to the second container engaging element between a first, partially engaged, position and second, fully engaged position, wherein in the first, partially engaged, position, at least one of the first and second container engaging elements is configured to at least partially engage the wall of the flexible container when received therein, and wherein in the second, fully engaged, position, the first and second container engaging elements are configured to engage, in combination, generally opposed portions of the wall of the flexible container when received therein.

16. The dispenser of claim 15, wherein in the second, fully engaged, position, the first and second container engaging elements are configured to engage, in combination, a majority of the wall of the flexible container when received therein.

17. The dispenser of any one of claims 12 to 16, wherein the first container engaging element is at least partially receivable within the second container engaging element and is removably connectable thereto.

18. The dispenser of any one of claims 12 to 17, wherein the first container engaging element includes the dispensing opening.

19. The dispenser of claim 2 or any one of claims 3-18 insofar as dependent thereon, wherein the dispenser body includes a tapered or grooved section, wherein the tapered or grooved section is adapated to engage the flexible container and the at least one container engaging element to prevent or reduce the likelihood of the flexible container moving relative to the at least one container engaging element.

20. A dispenser comprising a first container engaging element and a second container engaging element movable with respect to one another, the first and second container engaging elements adapted to engage a flexible container containing contents to be dispensed, wherein the first and second container engaging elements are configured to be arranged generally opposite one another when engaging the flexible container in order to maintain at least a portion of the flexible container in a predetermined position, wherein the contents of the flexible container are dispensed upon pressure being applied to the flexible container.
